(19) United States
(12) Patent Application Publication
(10) Pub. No.: US 2007/0137369 A1
(43) Pub. Date: Jun. 21, 2007

(54) Fixing structure without any fixing member for fixture of a driver

(75) Inventor: Cheng-Chung Hsu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/286,681

(22) Filed: Nov. 22, 2005

(51) Int. Cl. G05G 11/00

(52) U.S. Cl. 74/489

(57) ABSTRACT

A fixing structure without any fixing member is disclosed. The fixing structure is able to be installed in a housing of an electronic device for fixture of a driver. The fixing structure includes at least a supporting member fixed to the housing of the electronic device, and an elastic member connected to the driver. The driver is able to be fixed to the fixing structure through a fixing action achieved by the supporting member and the elastic member.

### BACKGROUND OF THE INVENTION

1. Field of the Invention

The present invention relates generally to a fixing structure without any fixing member for a driver and, more particularly, to a fixing structure able to be installed in a housing of an electronic device for fixture of the driver. In particular, without any screw or fixing member, the fixing structure is still capable of being fixed to the driver, such as a hard drive and the like.

2. Description of the Background Art

With the explosive development of information technology, electronic devices have become an evitable part for modern people in daily life. An electronic device comprises a plurality of electronic components, such as a hard drive and an optical drive. These electronic components are installed in and fixed to a housing of the electronic device by a fixing action achieved by screws for example. However, such the fixing action is inconvenient. Moreover, if the housing of the electronic device is not made perfect, the fixing action to fix the hard drive to the housing is hard to be achieved through the use of the screws. During the fixing action, a short circuit problem is likely to happen if the screws are fallen on a motherboard of the electronic device, and the motherboard is likely to be scratched when the fallen screws are picked up by a user. Please refer to FIG. 1, which is a schematic diagram of a fixing device 3 for fixture of a hard drive 5 according to the prior art. The fixing device 3 comprises a fixing base 31 having at least an aperture 32. The fixing device 3 is fixed to the hard drive 5 through the use of a screw 4 passing through the aperture 32.

However, such the fixing action for fixture of the hard drive 5 by passing the screw 4 through the aperture 32 is inconvenient and time-consuming. Moreover, if the housing, where the hard drive 5 is fixed to, is not made perfect, the fixing action to fix the hard drive 5 to the housing through the use of the screw 4 is hard to be achieved.

Therefore, the fixing action through the use of the fixing device 3 for fixture of the hard drive 5 is inconvenient and time-consuming. Moreover, during the fixing action, the short circuit problem is likely to happen if the screw 4 is fallen on the mother board of the electronic device, and the mother board is likely to be scratched when the fallen screw 4 are picked up by a user.

### SUMMARY OF THE INVENTION

Accordingly, it is an objective of the present invention to solve the aforementioned problems of the prior art by providing a fixing structure without any fixing member for fixture of a driver. The driver can be fixed to and separated from a housing of any electronic device without the use of a fixing action.

Another objective of the present invention is to provide a simple-structured fixing structure without any fixing member for fixture of a driver.

The fixing structure of the present invention includes a supporting member fixed to the housing of the electronic device and an elastic member connected to the driver, wherein the driver is able to be fixed to the fixing structure through the use of a fixing action achieved by the supporting member and the elastic member.

Of the fixing structure of the present invention, the supporting member includes at least a first positioning convex hole, a second positioning convex hole and a fixing slot, and the fixing slot is in the shape of a V-character or an arc.

Of the fixing structure, the elastic member includes at least a first positioning lug, a second positioning lug and a fixing lug. The first positioning lug of the elastic member is designed to be engaged with the first positioning convex hole of the supporting member, the second positioning lug of the elastic member is designed to be engaged with the second positioning convex hole of the supporting member, and the fixing lug of the elastic member is designed to be engaged with the fixing slot of the supporting member. When the elastic member is going to be fixed to the driver, first a first fixing hole of the elastic member is aimed at a first threaded hole of the driver, then a first bolt is used to pass through the elastic member and to be fixed to the driver, then a second fixing hole of the elastic member is aimed at a second threaded hole of the driver, and finally a second bolt is used to pass through the elastic member and to be fixed to the driver, so as to steadily fix the elastic member to the driver. A user is allowed to place a side of the driver, where the driver is not connected to the elastic member, in an L-shaped hook of the supporting member, and then press the elastic member to move toward a first moving direction. In result, the first positioning lug, the second positioning lug and the fixing lug of the elastic member are engaged with the first positioning convex hole, the second positioning convex hole and the fixing slot of the supporting member, and the driver is fixed to the fixing structure. The driver will not move forward or backward, because the fixing lug of the elastic member is engaged with and fixed to the fixing slot of the supporting member. If the user is to separate the driver from the supporting member, he can press the elastic member, and then the first positioning lug and the second positioning lug are separated from the first positioning convex hole and the second positioning convex hole of the supporting member respectively. Thus, the driver is able to be moved toward a second moving direction opposite to the first moving direction automatically, and to be separated from the supporting member. Therefore, the fixing structure of the present invention is easily to be fixed to or separated from the server.

As mentioned previously, the fixing action of the prior art for fixture of the hard drive by passing a screw through an aperture is inconvenient and time-consuming. Moreover, if the housing, where the hard drive is going to be fixed to, is not made perfect, the fixing action to fix the hard drive to the housing through the use of the screw is hard to be achieved. During the fixing action, a short circuit problem is likely to happen if the screws are fallen on a motherboard of the electronic device, and the motherboard is likely to be scratched when the fallen screws are picked up by a user.

In summary, in order to overcome the drawbacks of the prior art, the fixing structure without any fixing member for fixture of a driver of the present invention is designed to be fixed to a housing of an electronic device, for fixing driver to the fixing structure. Therefore, another fixing action achieve by the simple-structured fixing structure of the present invention is far more convenient than the fixing action of the prior art, without the use of any screw or fixing member.

### BRIEF DESCRIPTION OF THE DRAWINGS

FIG. 1 is a schematic diagram of a driver and a fixing device for fixture of the driver according to the prior art.

FIG. 2 is a schematic diagram of a supporting member of a fixing structure shown in FIG. 9.

FIG. 3 is a schematic diagram of an elastic member of the fixing structure shown in FIG. 9.

FIG. 4 is an explosive diagram of the driver and the fixing structure shown in FIG. 9.

FIG. 5 is an assembly diagram of the driver and the elastic member of the fixing structure shown in FIG. 9.

FIG. 6 is a side view of the driver and the fixing structure shown in FIG. 9 when the driver is going to be fixed to the fixing structure.

FIG. 7 is a side view of the driver and the fixing structure shown in FIG. 9 when the driver is fixed to the fixing structure.

FIG. 8 is a right hand side view of the driver and the fixing structure shown in FIG. 9 when the driver is already fixed to the fixing structure.

FIG. 9 is a schematic diagram of a drive and the fixing structure without any fixing member for fixture of the driver of the preferred embodiment according to the present invention.

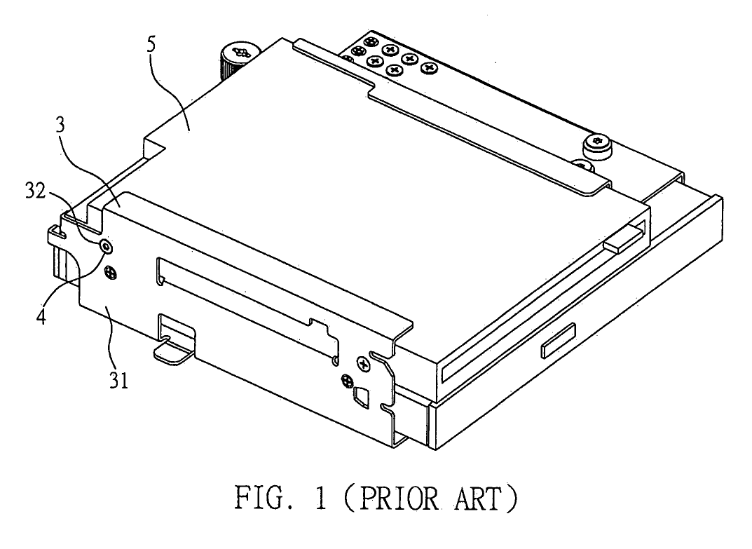

### DESCRIPTION OF THE PREFERRED EMBODIMENTS

The following description contains specific information pertaining to the implementation of the present invention. One skilled in the art will readily recognize other advantages and features of the present invention after reviewing what specifically disclosed in the present application. It is manifest that the present invention can be implemented and applied in a manner different from that specifically discussed in the present application. It should also be understood that the invention is not limited to the particular exemplary embodiments described herein, but is capable of many rearrangements, modifications, and substitutions without departing from the spirit of the present invention. Wherein, attention that the drawings according to the present invention are all simplified schematic diagrams should be paid to, i.e., they merely illustrate the components pertaining to the invention, and it is not limited to the components what illustrated, the number of the components, shape or proportion of size when actually implementing is a selective design, the layout of the component may be more complex.

The following embodiments further describe the technique means of the present invention in detail, but it is not used to limit the scope of the present invention.

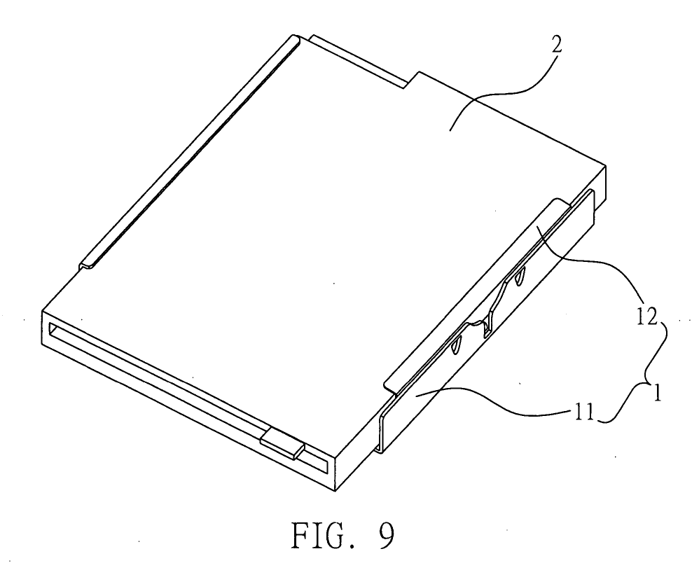

Please refer to FIG. 9, which is a schematic diagram of a drive and the fixing structure without any fixing member for fixture of the driver of the preferred embodiment according to the present invention. The fixing structure 1 is designed to be installed in a housing of an electronic device. A driver 2 is able to be fixed to the structure 1. The fixing structure 1 comprises at least a supporting member 11 fixed to the housing of the electronic device, and an elastic member 12 connected to the driver 2. The driver is able to be fixed to the housing of the electronic device through the use of a fixing action achieved by the elastic member 12 and the supporting member 11.

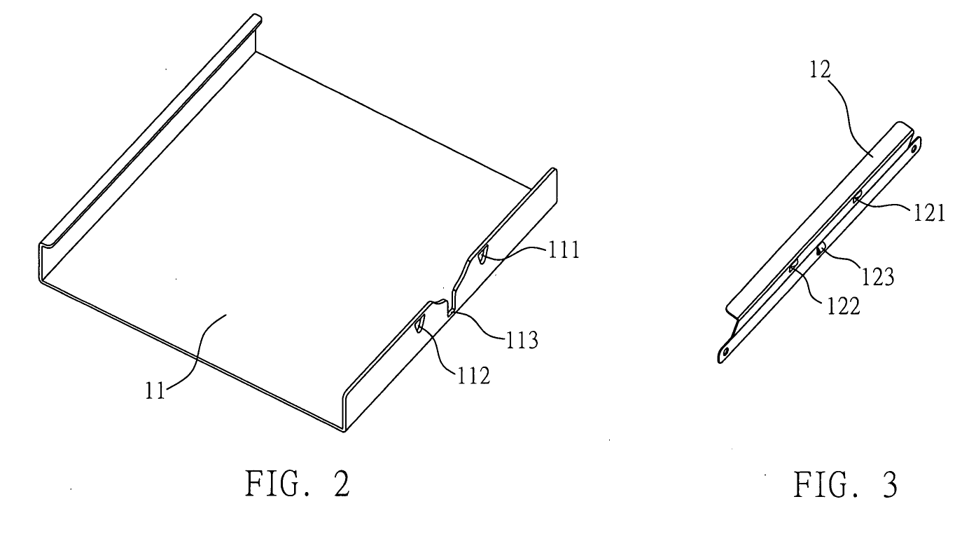

Please refer to FIG. 2. The supporting member 11 comprises at least a first positioning convex hole 111, a second positioning convex hole 112 and a fixing slot 113. The fixing slot 113 of the supporting member 11 is in the shape of an arc or a V-character.

Please refer to FIG. 2 and FIG. 3. The elastic member 12 comprises at least a first positioning lug 121, a second positioning lug 122 and fixing lug 123. The first positioning lug 121 of elastic member 12 is designed to be engaged with the first positioning convex hole 111 of the supporting member 11, the second positioning lug 122 of the elastic member 12 is designed to be engaged with the second positioning convex hole 112 of the supporting member 11, and the fixing lug 123 of the elastic member 12 is designed to be engaged with the fixing slot 113 of the supporting member 11.

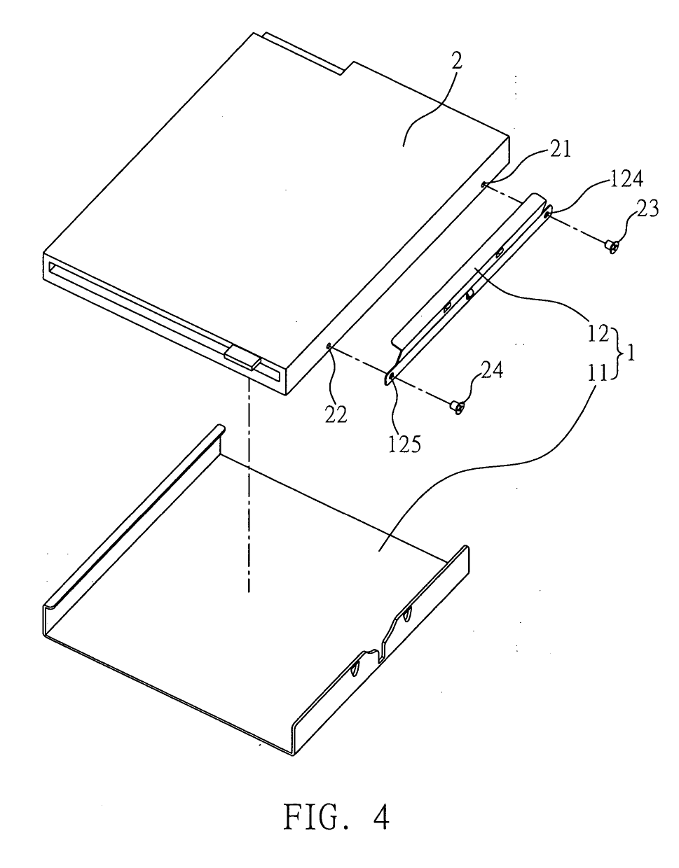

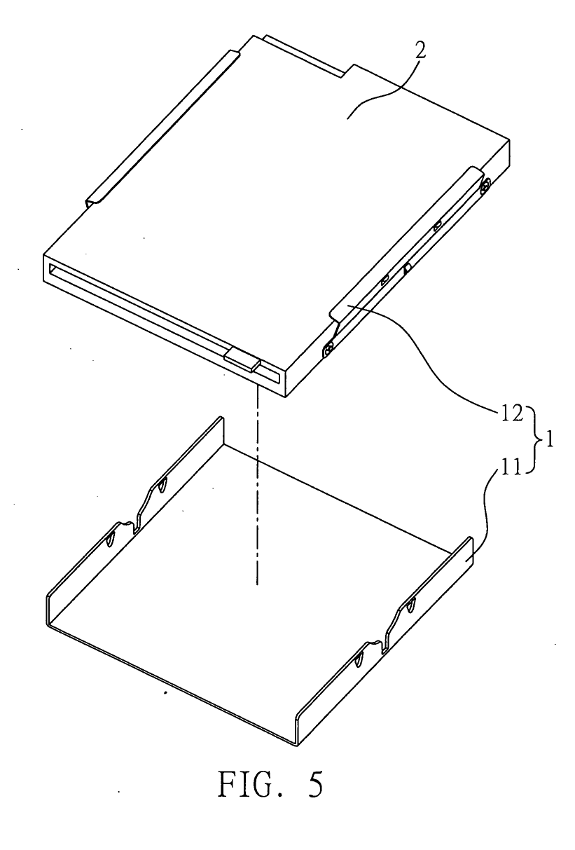

Please refer to FIG. 4, which is an explosive diagram of the driver 2 and the fixing structure 1. When the elastic member 12 is going to be fixed to the driver 2, first a first fixing hole 124 of the elastic member 12 is aimed at a first threaded hole 21 of the driver 2, then a first bolt 23 is used to pass through the elastic member 12 and to be fixed to the driver 2, then a second fixing hole 125 of the elastic member 12 is aimed at a second threaded hole 22 of the driver 2, and finally a second bolt 24 is used to pass through the elastic member 12 and to be fixed to the driver 2, so as to steadily fix the elastic member 12 to the driver 2. In order to save time to fixing the elastic member 12 to the driver 2, the driver 2 is already fixed to the elastic member 12 after the elastic member 12 is made.

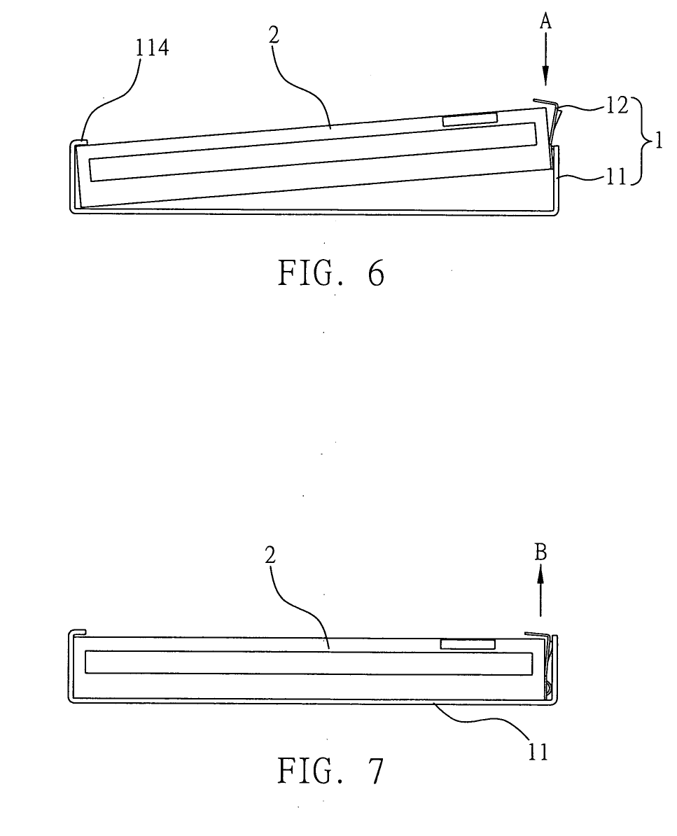

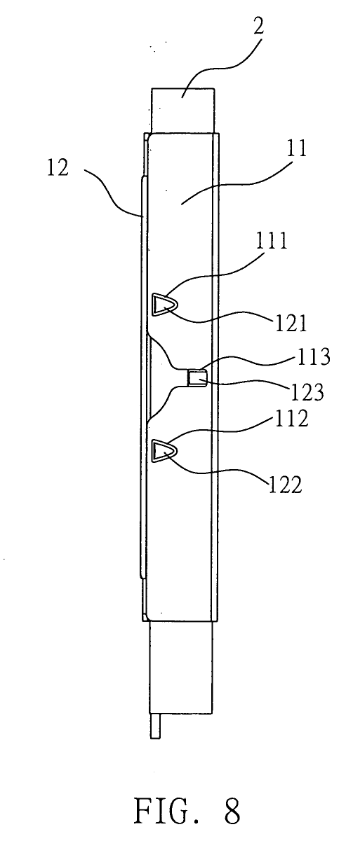

Please refer to FIG. 5, which is an assembly diagram of the driver 2 and the elastic member 12 of the fixing structure 1 of the present invention. Please refer to FIG. 6 and FIG. 8. FIG. 6 is a side view of the driver 2 and the fixing structure 1 when the driver 2 is going to be fixed to the fixing structure 1. FIG. 8 is a right hand side view of the driver 2 and the fixing structure 1 when the driver 2 is already fixed to the fixing structure 1. A user first places a side of the driver 2, where the driver 2 is not connected to the elastic member 12, in an L-shaped hook 114 of the supporting member 11, and then presses the elastic member 12 to move toward a first moving direction A. In result, the first positioning lug 121 (as shown in FIG. 8), the second positioning lug 122 and the fixing lug 123 of the elastic member 12 are engaged with the first positioning convex hole 121, the second positioning convex hole 122 and the fixing slot 113 of the supporting member 11, and the driver 2 is fixed to the fixing structure 1. The driver 2 will not move forward or backward, because the fixing lug 123 of the elastic member 12 is engaged with and fixed to the fixing slot 113 of the supporting member 11. Please refer to FIG. 7, which is a side view of the driver and the fixing structure 1 when the driver 2 is already fixed to the fixing structure 1. If the user is to separate the driver 2 from the supporting member 11, as shown in FIG. 6, he can press the elastic member 12, and then the first positioning lug 121 and the second positioning lug 122 are separated from the first positioning convex hole 111 and the second positioning convex hole 112 of the supporting member 11 respectively. Thus, the driver 2 is able to be moved toward a second moving direction B opposite to the first moving direction A automatically, and to be separated from the supporting member 11.

It should be noted that the fixing structure of the present invention can be applied to a variety of fields to meet any specific demand, without limited to the hard drive. The fixing structure can be applied to a fixing device of a compact disk drive and a housing of any electronic device.

The above-described exemplary embodiments are to describe various objects and features of the present invention as illustrative and not restrictive of the scope of the essential technical content according to the present invention, the essential technical content of the present invention is broadly defined in the appended claim, if the exemplary embodiments or method implemented by any one are completely identical to the following claim or only an equivalent change of the following claim, all that is considered to fall with the scope of the invention.

What is claimed is:

1. A fixing structure without any fixing members for fixture of a driver, the fixing structure being able to be installed in a housing of an electronic device, the fixing structure comprising:
a supporting member fixed to the housing of the electronic device; and
an elastic member connected to the driver;
wherein the driver is able to be fixed to the fixing structure through the use of a fixing action achieved by the supporting member and the elastic member.

2. The fixing structure of claim 1, wherein the supporting member comprises at least a first positioning convex hole, a second positioning convex hole and a fixing slot.

3. The fixing structure of claim 2, wherein the supporting member comprises a V-shaped or an arc-shaped fixing slot.

4. The fixing structure of claim 1, wherein the elastic member at least comprises a first positioning convex hole, a second positioning convex hole and a fixing lug.

5. The fixing structure of claim 4, wherein the first positioning lug of the elastic member is engaged with a first position convex hole of the supporting member.

6. The fixing structure of claim 4, wherein the second positioning lug of the elastic member is engaged with a second position convex hole of the supporting member.

7. The fixing structure of claim 4, wherein the fixing lug of the elastic member is engaged with a fixing slot of the supporting member.
